(19) United States
(12) Patent Application Publication
(10) Pub. No.: US 2013/0195554 A1
(43) Pub. Date: Aug. 1, 2013

(54) MOLDBOARD LOCK

(71) Applicants: Robert D. Rukavina, Arden Hills, MN (US); Timothy Miller, Saint Paul, MN (US)

(72) Inventors: Robert D. Rukavina, Arden Hills, MN (US); Timothy Miller, Saint Paul, MN (US)

(73) Assignee: Caterpillar Paving Products Inc., Minneapolis, MN (US)

(21) Appl. No.: 13/359,574

(22) Filed: Jan. 27, 2012

(51) Int. Cl. E01C 23/12; B23P 19/00

(52) U.S. Cl. 404/90; 29/426.1

(57) ABSTRACT

A milling machine including a chamber, a milling rotor, a rear door and a moldboard. The chamber has a front portion and a rear portion. The milling rotor is rotatably mounted transversely on the chamber. The rear door is mounted mounted adjacent to the milling rotor, in a substantially vertical position. The moldboard is coupled with the rear door. The moldboard is vertically movable with respect to the rear door between a retracted position and an extended position. A bulkhead is mounted on the chamber, adjacent to the milling rotor, in a substantially vertical position. The bulkhead includes a guide bar. A guide pin is coupled with the moldboard and configured to move within the guide bar. The guide pin is used to lock the moldboard in the extended position and to unlock the moldboard in the retracted position with respect to the bulkhead.

### TECHNICAL FIELD

The present disclosure relates to a milling machine, and more particularly to structures related to locking of a milling rotor during operation of the milling machine.

### BACKGROUND

Road milling machines are provided with a milling drum and a scraper blade which is in contact with a road surface to be milled. United States Patent Application Publication Number 2009/0044366 A1 relates a scraper device for the milling drum mounted in a construction machine. When in an operating position, the scraper blade is engaged with lateral retaining devices at lateral walls of a machine frame. The lateral retaining devices retain the scraper blade in a position running essentially orthogonally to a ground surface. A swivelling device is capable of swivelling the scraper blade about the swivelling axis when the scraper blade is disengaged from the lateral retaining devices. The swivelling device is provided at an upper end of an upper part of the scraper blade, with an operating device articulated between a permanently installed part of the construction machine and the upper part of the scraper blade.

### SUMMARY OF THE DISCLOSURE

In one aspect, the present disclosure provides a chamber, a milling rotor, a rear door and a moldboard. The chamber has a front portion and a rear portion. The milling rotor is rotatably mounted transversely on the chamber. The rear door is mounted transversely on the chamber. Further, the rear door is mounted adjacent to the milling rotor, in a substantially vertical position. The moldboard is coupled with the rear door. The moldboard is configured to direct milled material through when the moldboard is in a substantially vertical position. Also, the moldboard is vertically movable with respect to the rear door between a retracted position and an extended position. A bulkhead is mounted on the chamber. The bulkhead is adjacent to the milling rotor, positioned substantially vertically. Additionally, the bulkhead includes a guide bar. A guide pin is coupled with the moldboard and configured to move within the guide bar, in order to lock the moldboard in the extended position and to unlock the moldboard in the retracted position.

In another aspect, the disclosure provides a method of providing access to a milling rotor. The method places a moldboard in an extended position during a milling operation, wherein the moldboard is positioned for directing milled material through. The method raises the moldboard in a substantially vertical direction towards a rear door. The method then unlocks the moldboard from a bulkhead. The unlocking is based on a movement of a guide pin from a first position to a second position. Subsequently, the method pivots the rear door, in a retracted position of the moldboard, about a horizontal axis.

Other features and aspects of this disclosure will be apparent from the following description and the accompanying drawings.

### BRIEF DESCRIPTION OF THE DRAWINGS

FIG. 1 is a diagrammatic view of a milling machine having a chamber;

FIG. 2 is a diagrammatic view of the chamber having a moldboard and a rear door;

FIG. 3 is a front view of the moldboard having a guide pin;

FIG. 4 is an inner view of a bulkhead having a guide bar;

FIG. 5 is a rear view of the moldboard and the rear door; and

FIG. 6 is a flowchart depicting a process for unlocking of the moldboard.

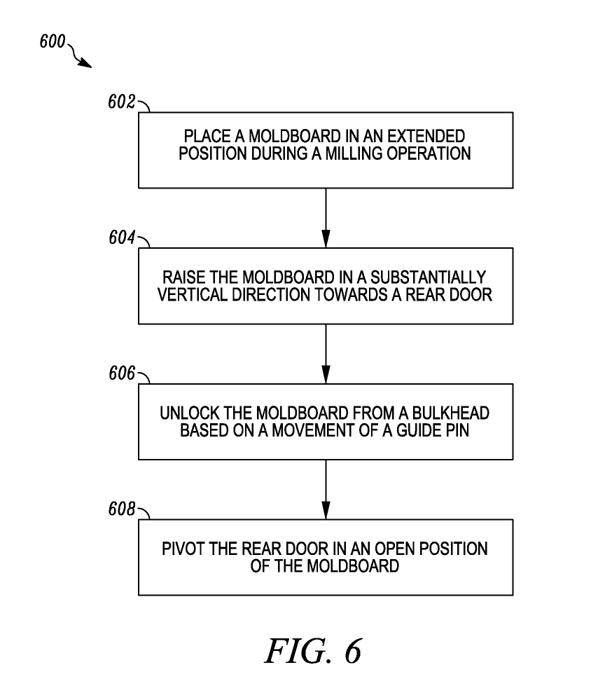

### DETAILED DESCRIPTION

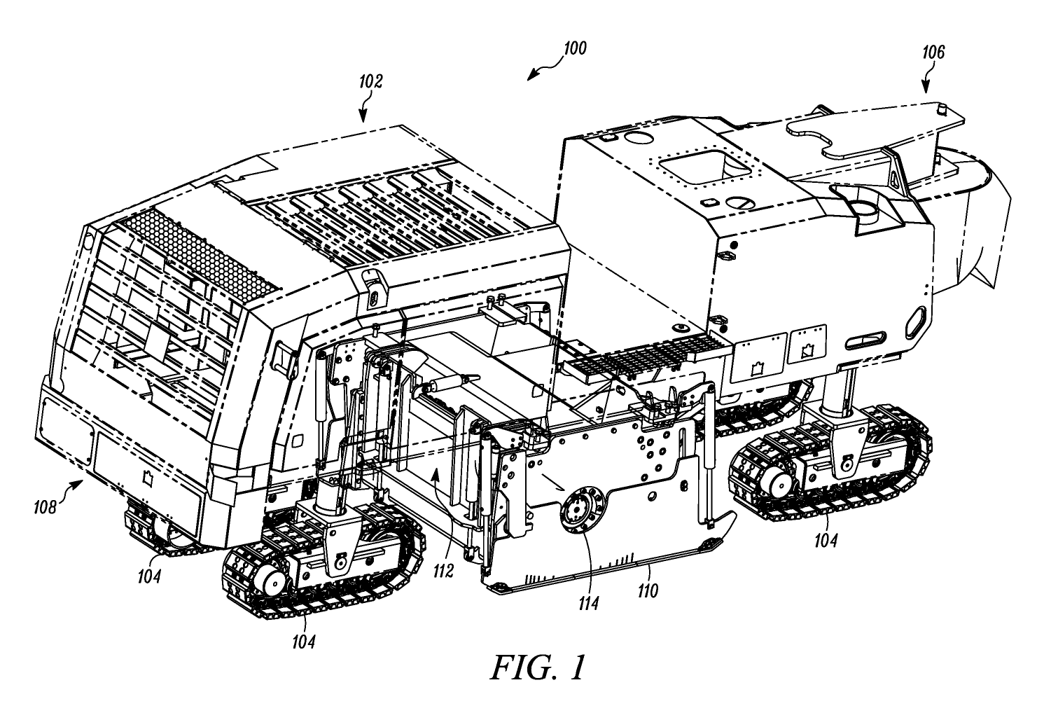

FIG. 1 is a diagrammatic representation of a milling machine 100 having a chassis 102 and running gears 104. The milling machine 100 may be used for milling of asphalt, concrete, and other road surface materials so that a worn surface may be removed and replaced with new material. The chassis 102 has a front end 106 and a rear end 108. A driver's position may be situated between the front end 106 and the rear end 108 of the chassis 102 of the milling machine 100.

In one embodiment, the milling machine 100 may place milled off material into a transporting vehicle (not shown in the figure) via a material-handling arrangement or conveyor, in order to load the milled off material. The transporting vehicle may include for example a dumper lorry, which drives ahead of the milling machine 100.

Referring to FIG. 1, a chamber 110 is mounted on a bottom side 112 of the chassis 102. The chamber 110 may be fitted in contact with a road or a milled surface. A person of ordinary skill in the art will appreciate that the size, shape and structure of the milling machine 100 as well the location and dimensions of the chamber 110 are merely on an exemplary basis and do not limit the scope of the disclosure.

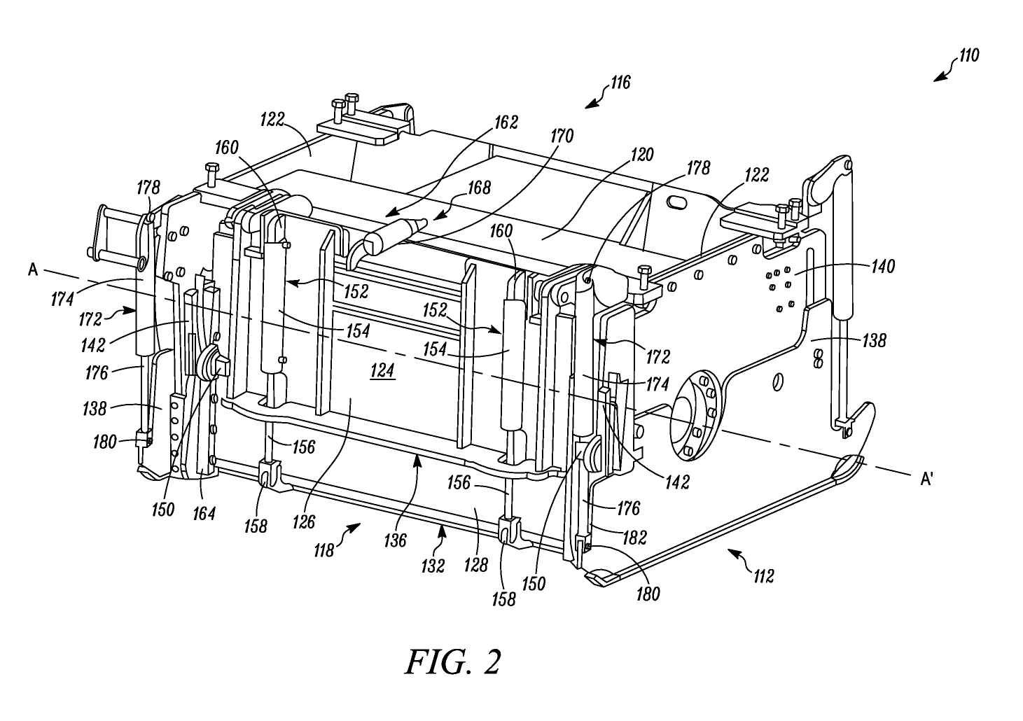

FIG. 2 illustrates a diagrammatic view of the chamber 110 of the milling machine 100. The chamber 110 encloses a milling rotor 114 by which material may be milled off the surface of the road. The milling rotor 114 is rotatably mounted transversely on the chamber 110. The milling rotor 114 is equipped with cutter teeth (not shown) and is powered for rotation about an axle by any well-known means (not shown).

The chamber 110 includes a front portion 116 and a rear portion 118. The chamber 110 may have a top plate 120. The top plate 120 of the chamber 110 extends between a bulkhead 122, provided on either end of the chamber 110. The top plate 120 forms the roof of an enclosing for the milling rotor 114. In one embodiment, the top plate 120 may have a number of apertures to direct the milled material through. In another embodiment, the chamber 110 may have a window 124 which allows the milled off material to exit to the rear portion 118 of the chamber 110 when open.

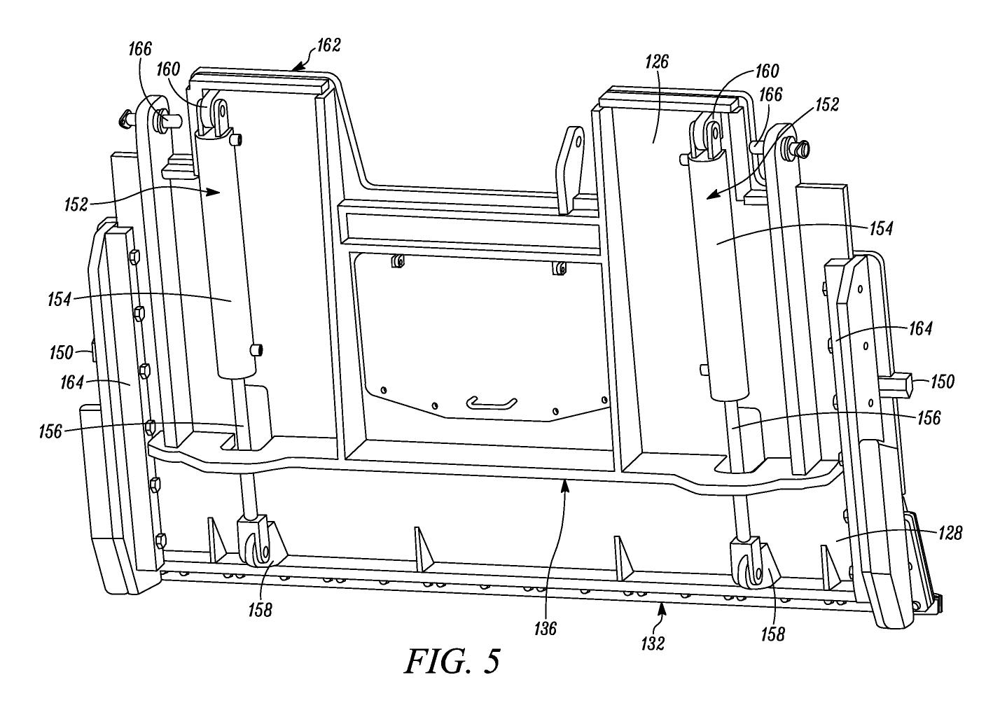

During a milling operation of the milling machine 100, access to the milling rotor 114 needs to be prevented. As explained with reference to FIGS. 2 to 5, the present disclosure relates to a locking mechanism to prevent access to the milling rotor 114 when the milling rotor 114 is in use, thereby avoiding hazardous accidents. Moreover, the present disclosure also allows access to the milling rotor 114 when the milling rotor 114 is not in use, thereby facilitating required cleaning and/or servicing of the milling rotor 114.

As shown in FIG. 2, the rear portion 118 of the chamber 110 may be closed by a rear door 126. The rear door 126 is mounted transversely on the chamber 110 in a substantially vertical position, adjacent to the milling rotor 114. A moldboard 128 may be coupled with the rear door 126. In one embodiment, the coupling may be provided using retainer plates (not shown in figure). The moldboard 128 may be configured to direct the milled material through when the moldboard 128 is in a substantially vertical position.

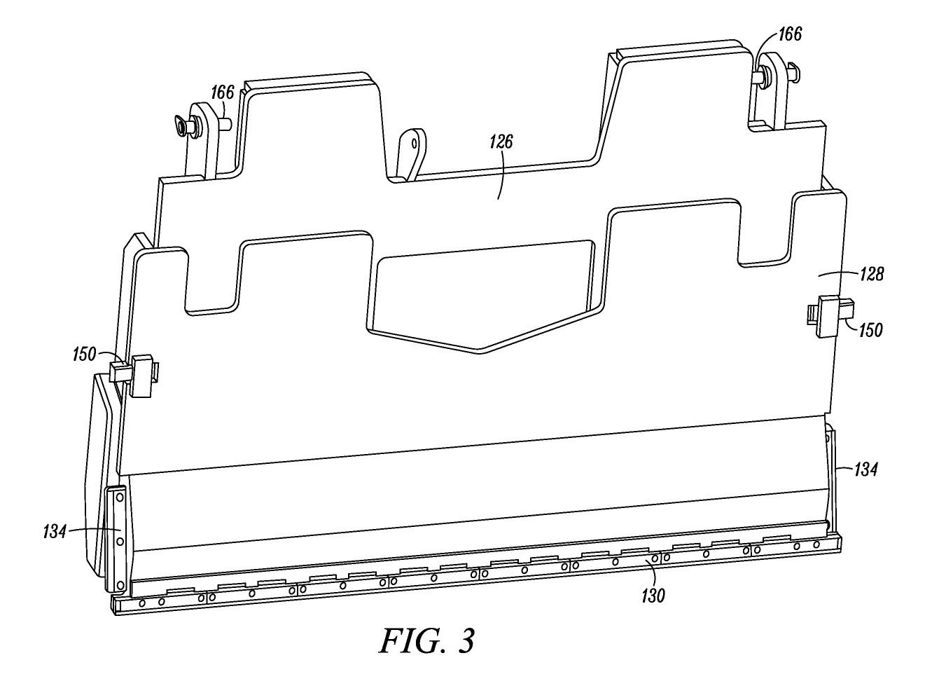

In one embodiment, as shown in FIG. 3, a bottom scraper bar 130 may be located at a lower edge 132 of the moldboard 128. Additionally, as depicted in FIG. 3, side scraper bars 134 may be attached on either side of the bottom scraper bar 130. The bottom scraper bar 130 and/or the side scraper bars 134 may scrape the milled surface when the milling operation is being performed by the milling machine 100, thereby cleaning and smoothening the milled surface.

During the milling operation of the milling machine 100, the moldboard 128, as shown in FIGS. 2, 3 and 5, is in an extended position in which the lower edge 132 of the moldboard 128 may be extended beyond a lower edge 136 of the rear door 126. Moreover, the lower edge 132 of the moldboard 128 is in contact with the milled surface, allowing the bottom scraper bar 130 and/or the side scraper bars 134 to scrape the milled surface. Additionally, when in the extended position the moldboard 128 may contain the milled material inside the chamber 110.

The moldboard 128 may be vertically movable with respect to the rear door 126 to a retracted position (not shown in figure). The moldboard 128 may be said to be in the retracted position when the lower edge 132 of the moldboard 128 is substantially in-line with the lower edge 136 of the rear door 126.

The chamber 110 further includes the bulkhead 122 located adjacent to the milling rotor 114 in a substantially vertical position. The bulkhead 122 extends lengthwise along the milling machine 100. In one embodiment, the chamber 110 may also include side plates 138 located adjacent to the bulk head 122 in a substantially vertical position. The side plates 138 may further include an inner side plate 140.

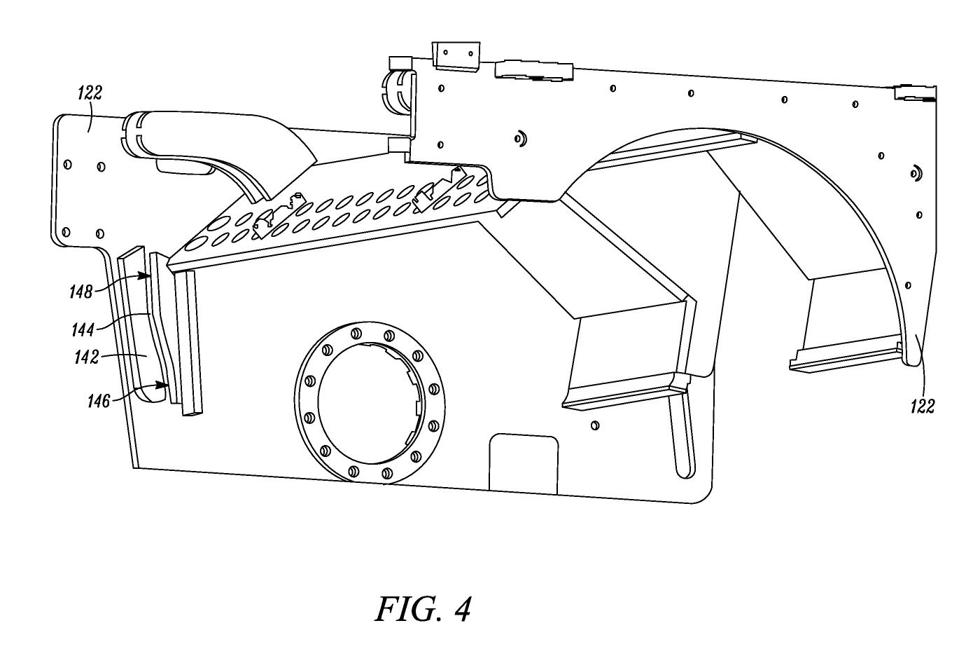

FIG. 4 illustrates an inner view of the bulkhead 122 mounted on the chamber 110. The bulkhead 122 may be provided on both side of the chamber 110. The bulkhead 122 may include a guide bar 142 which defines a groove 144. The guide bar 142 may be made up of any suitable material such as a metal, an alloy, and the like. The groove 144 may have a lower portion 146 and an upper portion 148. Moreover, an inner surface of the groove 144 may be greased and/or coated with any suitable material so as to reduce the effect of friction. A person of ordinary skill in the art will appreciate that the shape and dimensions of the groove 144 may vary without limiting the scope of the disclosure.

The groove 144 may define a path for the movement of a guide pin 150, which is coupled with the moldboard 128. As shown in FIG. 3, the guide pin 150 may be fixedly attached on either side of the moldboard 128 by means of a weld or a joint. The guide pin 150 may be a rectangular shaped block or may have any other suitable shape. The guide pin 150 may be made up of any suitable material for example metal, alloy, and the like. A person of ordinary skill in the art will appreciate that the structure, shape, dimension and placement of the guide pin 150 on the moldboard 128 may vary without limiting the scope of the disclosure.

The movement of the guide pin 150 in the groove 144 locks the moldboard 128 with respect to the bulkhead 122 of the chamber 110 and thus, prevents access to the milling rotor 114 during the milling operation. The guide pin 150 when engaged in the guide bar 142 may facilitate in holding the moldboard 128 in the extended position during operation of the milling rotor 114.

During the milling operation, the moldboard 128 may be positioned in the extended position, as shown in FIGS. 2, 3 and 5. When the moldboard 128 is in the extended position, the guide pin 150 is engaged in the lower portion 146 of the groove 144 (first position of the guide pin 150 in the groove 144), to lock the moldboard 128 with respect to the bulkhead 122. The chamber 110 may further include a moldboard actuator 152 to move the moldboard 128 from the extended position to the retracted position and thus, unlocks the moldboard 128 from the bulkhead 122.

The moldboard actuator 152 may include at least one combination of a first hydraulic cylinder 154 and a rod 156. A rod end 158 of the rod 156 is pivotally connected to the lower edge 132 of the moldboard 128. A cylinder end 160 is pivotally connected to an upper edge 162 of the rear door 126. A hydraulic circuit (not shown in figure) may be used for actuating the combination of the first hydraulic cylinder 154 and the rod 156. As the moldboard actuator 152 may be used to raise the moldboard 128 to the retracted position, the guide pin 150 may simultaneously move along the groove 144 of the guide bar 142 in a substantially vertical direction, from the lower portion 146 to the upper portion 148 of the groove 144 (second position of the guide pin 150 in the groove 144) and thus, unlock the moldboard 128 from the bulkhead 122.

In one embodiment, a side glide bar 164 may be provided on the chamber 110. The side glide bar 164 may assist in the substantially vertical movement of the moldboard 128 from the extended position to the retracted position. The side glide bar 164 may be affixed to the moldboard 128 and the moldboard 128 may slide/glide on the rear door 126 over the side glide bar 164. A person of ordinary skill in the art will appreciate that the vertical movement of the moldboard 128 may be limited by a distance defined by the length of the side glide bar 164 provided on the moldboard 128.

Subsequently, the rear door 126 may be swung open once the moldboard 128 is in the retracted position and is unlocked from the bulkhead 122. The rear door 126 may be hingedly fixed to the chamber 110 by pivot pins 166. The pivot pins 166 may be located at the upper edge 162 of the rear door 126. The chamber 110 may further include a rear door actuator 168 to open the rear door 126 and provide access to the milling rotor 114. The rear door actuator 168 may be fixed to the top plate 120 of the chamber 110. The rear door actuator 168 may include a second hydraulic cylinder 170 connected to the upper edge 162 of the rear door 126. One end of the second hydraulic cylinder 170 is attached to the top plate 120 of the chamber 110 and the other end is connected to the rear door 126.

In one embodiment, the rear door actuator 168 may include a hydraulic circuit (not shown in figure) coupled to the second hydraulic cylinder 170. The hydraulic circuit may be used to actuate the second hydraulic cylinder 170. When the moldboard 128 is in the retracted position, the rear door actuator 168 may be used to swing the rear door 126 outwards and upwards about the pivot pins 166, thereby orienting the rear door 126 about a substantially horizontal axis AA′.

In one embodiment, the chamber 110 may also include a side plate actuator 172 to swing open the side plates 138 and the bulkhead 122, in order to provide a sideways access to the milling rotor 114. The side plate actuator 172 may include a combination of a third hydraulic cylinder 174 and a rod 176, where one end 178 of the third hydraulic cylinder 174 being attached to the top plate 120 of the chamber 110 and a rod end 180 being attached to an edge 182 of the side plate 138. The side plate actuator 172 may be used to move the side plate 138 and the bulkhead 122 in a substantially vertical direction, thereby allowing sideways access to the milling rotor 114.

It should be apparent that when the moldboard 128 is in the milling operation, the overall weight of the assembly may cause the moldboard 128 to move vertically downward to contact the milled surface. This weight may cause the bottom scraper bars 130 and/or the side scraper bars 134 to clean and scrape the milled surface. Occasionally, an operator of the milling machine 100 may provide a limited downward force to scrape the milled surface with more force, depending on the nature of the surface to be milled.

### INDUSTRIAL APPLICABILITY

The milling machine 100 described above may be used for the milling of material such as asphalt, concrete and other road milling material, by the use of the milling rotor 114. The milling rotor 114 may be enclosed in the chamber 110 of the milling machine 100 by the moldboard 128 and the rear door 126 assembly. During the milling operation of the milling machine 100, severe damage may be caused to the chamber 110 and its associated structures if the moldboard 128 and/or the rear door 126 of the milling machine 100 is left unlocked or open. Moreover, it may be hazardous to an operator of the milling machine 100 to leave the moldboard 128 and the rear door 126 assembly unlocked with respect to the chamber 110, while the milling rotor 114 is in use. The guide pin 150 and the guide bar 142 assembly described above may be used to effectively lock the moldboard 128 and the rear door 126 with respect to the bulkhead 122 during the milling operation.

Initially, as shown in step 602, the moldboard 128 may be placed in the extended position during the milling operation. As explained above with reference to FIGS. 2, 3 and 5, when in the extended position, the moldboard 128 may be in contact with the milled surface such that the milled material may be directed through. Moreover, in the extended position, the guide pin 150 may be engaged in the lower portion 146 of the groove 144 (first position of the guide pin 150 in the guide bar 142). In this position of the guide pin 150, the moldboard 128 is locked with respect to the bulkhead 122. This may assist in preventing access to the milling rotor 114 during the milling operation.

In an embodiment, it may be required to clean or service the milling rotor 114 after a pre-determined period of operation of the milling rotor 114. Thus, in such situations, moldboard 128 needs to be unlocked from the bulkhead 122 to provide an access to the milling rotor 114.

At step 604, the moldboard 128 may be raised in a substantially vertical direction towards the rear door 126. The movement of the moldboard 128 from the extended position to the retracted position with respect to bulkhead 122 may be achieved using the moldboard actuator 152. The movement of the moldboard 128, initiated by the moldboard actuator 152, may move the guide pin 150 to the upper portion 148 of the groove 144 (second position of the guide pin 150 in the guide bar 142), and thus, unlock the moldboard 128 from the bulkhead 122, as shown in step 606.

A person of ordinary skill in the art will appreciate that the unlocking of the moldboard 128 and the rear door 126 arrangement is coupled with the change in the position of the moldboard 128 from the extended position to the retracted position. Moreover, the unlocking of the moldboard 128 and the rear door 126 assembly with respect to the bulkhead 122 of the chamber 110 may occur simultaneously and automatically with the movement of the guide pin 150 in the groove 144 defined by the guide bar 142.

Subsequently, at step 608, the rear door 126 and the moldboard 128 may be pivoted about the pivot pins 166 which are located on the upper edge 162 of the rear door 126. In one embodiment, the rear door actuator 168 may be used to swing the moldboard 128 and the rear door 126 assembly outward and upwards, the pivoting being parallel to the horizontal axis AA'. The pivoting of the rear door 126 and the moldboard 128 may facilitate in accessing the milling rotor 114 for servicing and/or cleaning In one embodiment, the side plates 138 and the bulkhead 122 of the chamber 110 may also be moved in a substantially vertical direction by means of the side plate actuator 172, to allow sideways access to the milling rotor 114 of the milling machine 100.

The present disclosure thereby provides a potentially safe and hazard free solution. The guide bar 142 and the guide pin 150 together provide a cost effective and structurally simple assembly to provide an effective locking and unlocking mechanism for the moldboard 128 and the rear door 126 of the milling machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A milling machine comprising:
a chamber having a front portion and a rear portion;
a milling rotor rotatably mounted transversely on the chamber;
a rear door mounted transversely on the chamber, the rear door mounted adjacent to the milling rotor, in a substantially vertical position;
a moldboard coupled with the rear door, the moldboard configured to direct milled material through when the moldboard is in a substantially vertical position, the moldboard being vertically movable with respect to the rear door between a retracted position and an extended position;
a bulkhead mounted on the chamber, adjacent to the milling rotor, in a substantially vertical position, wherein the bulkhead includes a guide bar; and
a guide pin coupled with the moldboard and configured to move within the guide bar to lock the moldboard in the extended position and to unlock the moldboard in the retracted position.

2. The milling machine of claim 1, wherein the guide bar defines a groove within which the guide pin is configured to move to lock the moldboard with respect to the bulkhead in the extended position and to unlock the moldboard with respect to the bulkhead in the retracted position.

3. The milling machine of claim 1, wherein the extended position of the moldboard is an operating position for the moldboard.

4. The milling machine of claim 1, wherein at least one guide pin is fixedly attached to the moldboard.

5. The milling machine of claim 1, wherein the chamber further includes a side plate, the side plate is located adjacent to the bulkhead in a substantially vertical position.

6. The milling machine of claim 1, wherein the rear door is pivotable at an upper edge about a substantially horizontal axis, in the retracted position of the moldboard.

7. The milling machine of claim 1, wherein the moldboard comprises a bottom scraper bar for contacting a milled surface.

8. The milling machine of claim 1, wherein the moldboard comprises a side scraper bar for contacting a milled surface.

9. The milling machine of claim 1, wherein the moldboard further comprises a side glide bar configured to move the moldboard with respect to the rear door, in a substantially vertical direction, between the extended position and the retracted position.

10. The milling machine of claim 1 further comprising a moldboard actuator for moving the moldboard between the extended position and the retracted position.

11. The milling machine of claim 10, wherein the moldboard actuator comprises:
a first hydraulic cylinder and rod combination, having a rod end pivotally connected to a lower edge of the moldboard and a cylinder end pivotally connected to an upper edge of the rear door; and
a hydraulic circuit for actuating the first hydraulic cylinder and rod combination.

12. The milling machine of claim 1, wherein the rear door comprises a pivot pin to enable the rear door to pivot about a horizontal axis.

13. The milling machine of claim 1, further comprising a rear door actuator for pivoting the rear door about a horizontal axis, in the retracted position of the moldboard.

14. The milling machine of claim 13, wherein the rear door actuator comprises:
a second hydraulic cylinder connected to an edge of the rear door; and
a hydraulic circuit for actuating the second hydraulic cylinder.

15. A method of providing access to a milling rotor, the method comprising:
placing a moldboard in an extended position during a milling operation, wherein the moldboard is positioned for directing milled material through;
raising the moldboard in a substantially vertical direction towards a rear door;
unlocking the moldboard from a bulkhead based on a movement of a guide pin from a first position to a second position; and
pivoting the rear door, in a retracted position of the moldboard, about a horizontal axis.

16. A chamber deployed in milling machine, the chamber comprising:
a milling rotor rotatably mounted transversely on the chamber;
a rear door mounted transversely on the chamber, the rear door mounted adjacent to the milling rotor, in a substantially vertical position;
a moldboard coupled with the rear door, the moldboard configured to direct milled material through when the moldboard is in a substantially vertical position, the moldboard being vertically movable with respect to the rear door between a retracted position and an extended position;
a bulkhead mounted on the chamber, adjacent to the milling rotor, in a substantially vertical position, wherein the bulkhead includes a guide bar;
a guide pin coupled with the moldboard and configured to move within the guide bar to lock the moldboard in the extended position and to unlock the moldboard in the retracted position;
a first hydraulic cylinder and rod combination, having a rod end pivotally connected to a lower edge of the moldboard and a cylinder end pivotally connected to an upper edge of the rear door, wherein the first hydraulic cylinder and rod combination is configured to move the moldboard from the extended position to the retracted position; and
a second hydraulic cylinder connected to an edge of the rear door, wherein the second hydraulic cylinder is configured to pivot the rear door, along with the moldboard in the retracted position, to a position that allows access to the milling rotor.
